(19) United States
(12) Patent Application Publication
(10) Pub. No.: US 2007/0008249 A1
(43) Pub. Date: Jan. 11, 2007

(54) Plasma display device and driving method thereof

(76) Inventors: Kazuhiro Ito, Chunan-si (KR); Byung-Gwon Cho, Chunan-si (KR)

Correspondence Address: CHRISTIE, PARKER & HALE, LLP, PO BOX 7068, PASADENA, CA, 91109-7068, US

(21) Appl. No.: 11/482,606

(22) Filed: Jul. 6, 2006

(30) Foreign Application Priority Data
Jul. 6, 2005 (KR) 10-2005-0060666

(51) Int. Cl. G09G 3/28

(52) U.S. Cl. 345/67

(57) ABSTRACT

Reset, address, and sustain operations of a plasma display device are performed by applying a driving waveform to a scan electrode while biasing a sustain electrode at a ground voltage allowing a driving board for driving the sustain board to be eliminated. Since a low voltage is applied to the scan electrode while biasing the sustain electrode at the ground voltage during the reset period, a potential formed by a wall charge may be greater at the scan electrode than at the address electrode. In addition, a misfiring discharge may be prevented during the sustain period when a low voltage applied to the scan electrode during the sustain period is set to be greater than the scan voltage of a scan pulse applied to the scan electrode during the address period.

### CROSS-REFERENCE TO RELATED APPLICATION

This application claims priority to and the benefit of Korean Patent Application No. 10-2005-0060666 filed in the Korean Intellectual Property Office on Jul. 6, 2005, the entire content of which is incorporated herein by reference.

### BACKGROUND OF THE INVENTION

(a) Field of the Invention

The present invention relates to a plasma display device and a driving method thereof.

(b) Description of the Related Art

A plasma display panel (PDP) is a flat panel display that uses plasma generated by gas discharge to display characters or images. It includes, depending on its size, more than several scores to millions of pixels arranged in a matrix pattern.

One frame of the PDP is divided into a plurality of subfields, and each subfield includes a reset period, an address period, and a sustain period.

The reset period is for initializing the status of each discharge cell so as to facilitate an addressing operation on the discharge cell, and the address period is for selecting turn-on/turn-off cells (i.e., cells to be turned on or off) and accumulating wall charges to the turn-on cells (i.e., addressed cells). The sustain period is for causing a discharge for displaying an image on the addressed cells.

In order to perform the above-noted operation, sustain pulses are alternately applied to the scan electrodes and the sustain electrodes during the sustain period, and reset waveforms and scan waveforms are applied to the scan electrodes during the reset period and the address period. Therefore, a scan driving board for driving the scan electrodes and a sustain driving board for driving the sustain electrodes have been separately needed, and in this case, a problem arises as to mounting the driving boards on a chassis base, and the cost increases because of the separate driving boards.

Further, when combining the two driving boards into a single combined board, schemes have been proposed wherein the single board has been put at an end of the scan electrodes and an end of the sustain electrodes is extended to reach the combined board. However, when the two driving boards are combined into a single board as such, the impedance component formed at the extended sustain electrodes is increased.

### SUMMARY OF THE INVENTION

In accordance with the present invention a plasma display device and a driving method therefor is provided wherein driving boards are combined into a single combined board for separately driving scan electrodes and sustain electrodes. In addition, a driving waveform appropriate for a single combined board is provided.

An exemplary driving method of a plasma display device according to an embodiment of the present invention is a driving method for a plasma display device by a plurality of subfields divided from a frame, wherein the plasma display device has a plurality of first electrodes, a plurality of second electrodes, and a plurality of third electrodes crossing the first and second electrodes, and has a discharge cell formed by the first, second, and third electrodes.

The driving method includes, in at least one subfield in which the second electrode is biased at a first voltage, initializing the discharge cell by gradually reducing a voltage of the first electrode from a second voltage to a third voltage, respectively applying a fourth voltage and a fifth voltage greater than the first voltage to the first electrode and the third electrode of a discharge cell to be turned on, and applying a pulse train alternately having a sixth voltage greater than the first voltage and a seventh voltage less than the first voltage and greater than the forth voltage to the first electrode.

An exemplary plasma display device according to an embodiment of the present invention includes a plasma display panel having a plurality of first electrodes, a plurality of second electrodes, and a plurality of third electrodes crossing the first and second electrodes, and a chassis base facing the plasma display panel and including a driving board for applying a driving waveform to the second and third electrodes so as to display an image on the plasma display panel and for biasing the first electrode to a first voltage while the image is displayed.

For at least one subfield, in an address period, the driving board biases the plurality of second electrodes at a first voltage, sequentially applies a second voltage to the plurality of first electrodes, selectively applies a third voltage greater than the first voltage to the plurality of third electrodes, and in a sustain period, alternately applies high/low levels of a sustain discharge pulse to the plurality of first electrodes. An absolute value of a low level of the sustain pulse is less than an absolute value of the second voltage.

### BRIEF DESCRIPTION OF THE DRAWINGS

FIG. 1 shows an exploded perspective view of a plasma display device according to an exemplary embodiment of the present invention.

FIG. 2 shows a schematic view of a plasma display panel according to an exemplary embodiment of the present invention.

FIG. 3 shows a schematic top plan view of a chassis base according to an exemplary embodiment of the present invention.

FIG. 4 shows a diagram representing a driving waveform according to an exemplary embodiment of the present invention.

FIG. 5 shows a diagram representing another driving waveform according to an exemplary embodiment of the present invention.

### DETAILED DESCRIPTION OF THE EMBODIMENTS

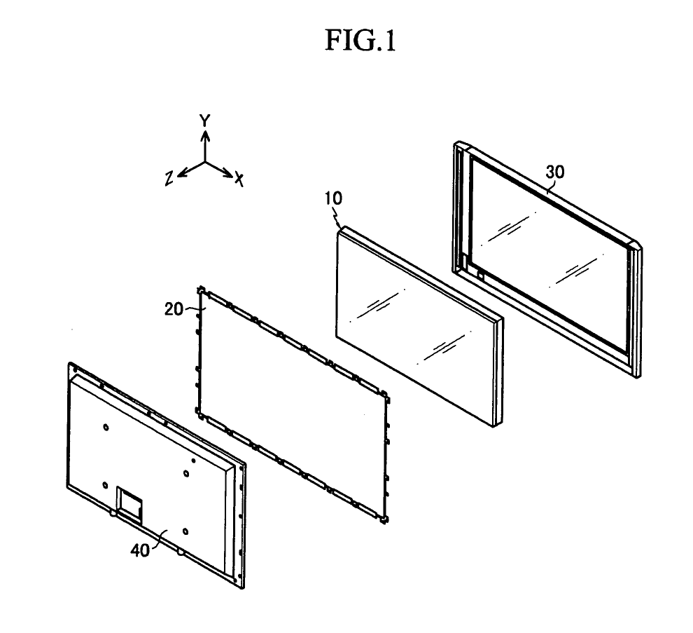

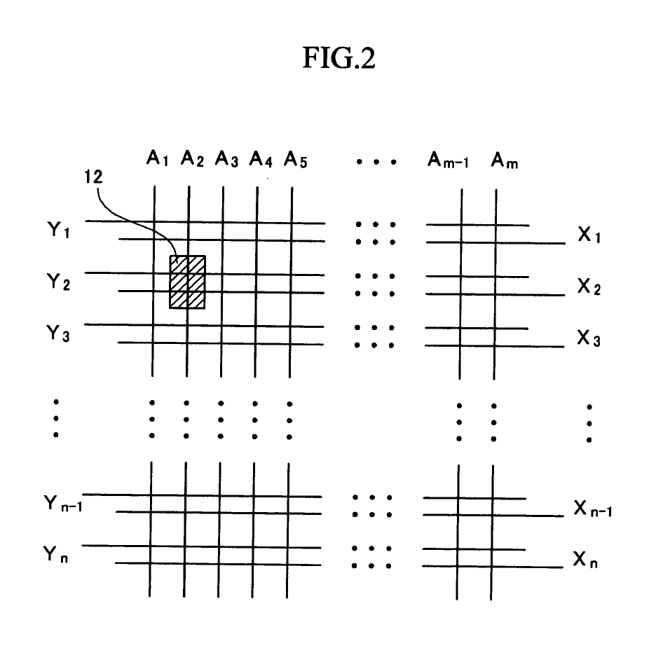

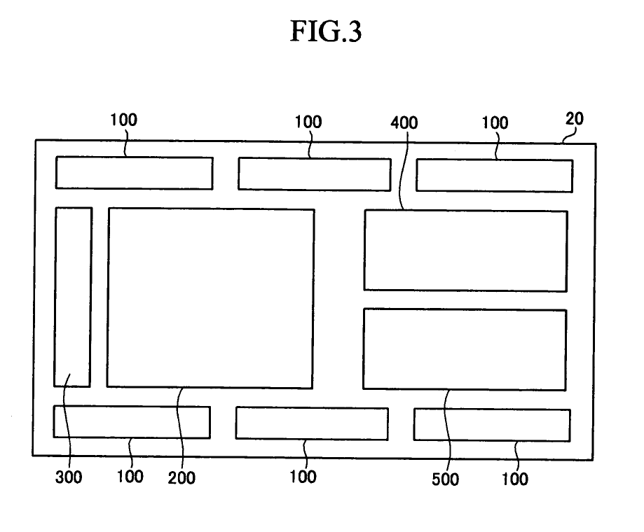

First, a schematic configuration of a plasma display device according to an embodiment of the present invention is described in more detail with reference to FIG. 1, FIG. 2 and FIG. 3.

As shown in FIG. 1, the plasma display device includes a plasma display panel 10, a chassis base 20, a front case 30, and a rear case 40. The chassis base 20 is combined with the plasma display panel 10 and disposed opposite to an image display side of the plasma display panel 10. The front and rear cases 30, 40 are respectively combined with and disposed to the front of the plasma display panel 10 and the rear of the chassis base 20, so as to form a plasma display device.

As shown in FIG. 2, the plasma panel 10 includes a plurality of address electrodes A1 to Am elongated in a column direction, and a plurality of scan electrodes Y1 to Yn and a plurality of sustain electrodes X1 to Xn elongated in a row direction. The sustain electrodes X1 to Xn are formed in respective correspondence to the scan electrodes Y1-Yn, and ends of the sustain electrodes are connected in common. The plasma panel 10 includes a substrate (not shown) having the sustain and scan electrodes X1 to Xn and Y1 to Yn formed thereon, and a substrate (not shown) having the address electrodes A1 to Am formed thereon. The two substrates are disposed to face each other interposing a discharge space therebetween such that the address electrodes A1 to Am perpendicularly cross both of the scan electrodes Y1 to Yn and the sustain electrodes X1 to Xn. A discharge space formed at an area where the address electrodes A1 to Am cross the sustain and scan electrodes X1 to Xn and Y1 to Yn forms a discharge cell 12.

As shown in FIG. 3, driving boards 100, 200, 300, 400, 500 for driving the plasma display panel 10 are formed on the chassis base 20. Address buffer boards 100 may be formed on a top and a bottom of the chassis base 20, and may be formed as a single board or a combination of a plurality of boards. FIG. 3 illustrates that address buffer boards 100 are respectively formed on a top and a bottom of the chassis base 20. However, it should be noted that such a configuration relates to a dual driving scheme. That is, in a single driving scheme, the address buffer board 100 is formed on one of the top and the bottom of the chassis base 20. The address buffer board 100 receives an address driving control signal from an image processing and controlling board 400 and applies a voltage for selecting a turn-on cell to the respective address electrodes A1 to Am.

A scan driving board 200 may be located at a left portion of the chassis base 20 and be coupled to the scan electrodes Y1-Yn through a scan buffer board 300. The sustain electrodes X1 to Xn are biased at a predetermined voltage. During an address period, the scan buffer board 300 applies a voltage for sequentially selecting scan electrodes Y1-Yn to the scan electrode Y1-Yn. The scan driving board 200 receives a driving signal from the image processing and controlling board 400 and applies the driving voltage to the scan electrode Y1-Yn. While the scan driving board 200 and the scan buffer board 300 are shown to the left in the chassis base 20 in FIG. 3, they may be provided to the right in the chassis base 20. In addition, the scan buffer board 300 and the scan driving board 200 may be integrally formed.

The image processing and controlling board 400 that externally receives an image signal generates a control signal for driving the address electrodes A1-Am and a control signal for driving the scan and sustain electrodes Y1-Yn and X1-Xn, and then applies the control signals to the address driving board 100 and the scan driving board 200. A power supply board 500 supplies power for driving the plasma display device. The controlling board 400 and the power supply board 500 are provided on a central area of the chassis base 20.

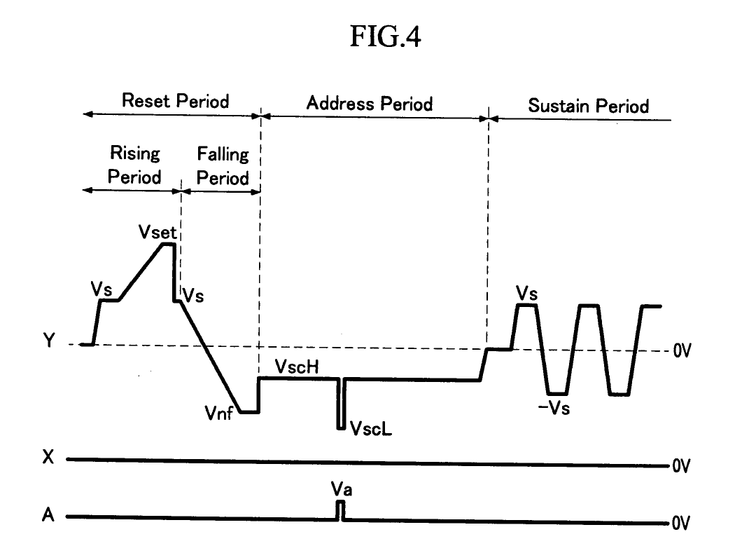

Driving waveforms of the plasma display panel according to an exemplary embodiment of the present invention will now be described with reference to FIG. 4 which shows a diagram for representing a driving waveform according to one exemplary embodiment of the present invention. Hereinafter, an exemplary description is for a driving waveform applied to a single sustain electrode (hereinafter, referred to as “X electrode”), a single scan electrode (hereinafter, referred to as “Y electrode”), and a single address electrode (hereinafter, referred to as “A electrode”) for forming only one cell will be described for convenience. In the driving waveform shown in FIG. 4, the Y electrode receives a voltage from the scan driving board 200 and the scan buffer board 300, and the A electrode receives a voltage from the address buffer board 100. The X electrode is biased at a reference voltage (represented as a ground voltage 0V in FIG. 4), and accordingly, a description of a voltage applied to the X electrode will not be described in further detail.

As shown in FIG. 4, a subfield has a reset period, an address period, and a sustain period. The reset period has a rising period and a falling period.

In the rising period of the reset period, the voltage of the Y electrode is gradually increased from a voltage Vs to a voltage Vset while the A electrode is maintained at the reference voltage (represented as 0V in FIG. 4). FIG. 4 illustrates that the voltage of the Y electrode increases in a ramp style. A weak discharge is generated between the Y and X electrodes and between Y and A electrodes while the voltage of the Y electrode is increased, and (−) wall charges are formed on the Y electrode and (+) wall charges are formed on the X and A electrodes. In addition, in the case that the voltage of the Y electrode gradually changes as shown in FIG. 4, a weak discharge is caused in a cell, and accordingly, wall charges are formed such that a sum of an externally applied voltage and the wall charge may be maintained at a discharge firing voltage. The above-described scheme is disclosed in U.S. Pat. No. 5,745,086 by Weber.

The voltage Vset is a voltage high enough to fire a discharge in cells of any condition because every cell has to be initialized in the reset period. Generally, the voltage Vs is greater than or equal to the voltage applied to the Y electrode during the sustain period, and is less than a voltage for firing a discharge between the Y electrode and X electrode.

In the falling period of the reset period, the voltage of the Y electrode is gradually reduced from the voltage Vs to a voltage Vnf while the voltage of the A electrode is maintained at the reference voltage. Then, the weak discharge is generated between the Y and X electrodes and between the Y and A electrodes while the voltage of the Y electrode is reduced, and accordingly, the (−) wall charges formed on the Y electrode and the (+) wall charges formed on the X and A electrodes are eliminated. The voltage Vnf is set to be close to a discharge firing voltage between the Y and X electrodes. Then a wall voltage between the Y and X electrodes approaches 0V, and therefore a cell that does not have an address discharge in the address period may be prevented from misfiring in the sustain period. The wall voltage between the Y and A electrodes is determined by a level of the voltage Vnf because the voltage of the A electrode is maintained at the reference voltage.

Further, a falling start voltage of the Y electrode may be set to be a lower voltage in the falling period of the reset period.

Generally, as a voltage slope of an electrode becomes gentler, the discharge is generated more weakly. Therefore, when the falling start voltage of the Y electrode is set to be less than the voltage Vs of the Y electrode, a falling slope of the Y electrode may be set to be gentler in the falling period. As a result, the strong discharge can be prevented although the strong discharge is generated in the rising period because the voltage of the Y electrode is varied at a slower speed. At this time, it is not necessary to form an additional voltage to apply the falling start voltage to the Y electrode when the falling start voltage is set to be 0V.

For example, when the falling start voltage of the Y electrode is 0V, no discharge is generated because a difference between voltages applied to the X and Y electrodes and a difference between voltages applied to the A and Y electrodes are 0V at the time that the Y electrode is reduced. When the voltage of the Y electrode is gradually reduced, the weak discharge is generated such that a difference between the wall voltage formed on the cell and the externally applied voltage exceeds the discharge firing voltage.

Subsequently, during the address period for selecting turn-on cells, an address pulse of a voltage VscL and an address pulse of a voltage Va are respectively applied to the Y electrode and the A electrode of the turn-on cell. A non-selected Y electrode is biased at a voltage VscH which is higher than the voltage VscL, and the reference voltage is applied to the A electrode of the cell being turned off. The scan buffer board 300 selects a Y electrode to be applied with the scan pulse of VscL, from among the Y electrodes Y1 to Yn. For example, in the single driving method, the Y electrodes may be selected in an order of arrangement of the Y electrodes in the column direction. When a Y electrode is selected, the address buffer board 100 selects cells to be turned on among the cells formed on the selected Y electrode. That is, the address buffer board 100 selects A electrodes to which the address pulse of the voltage Va is applied among the A electrodes A1 to Am.

In more detail, the scan pulse of the voltage VscL is first applied to the scan electrode (Y1 shown in FIG. 2) in a first row, and at the same time, the address pulse of the voltage Va is applied to the A electrode on the cells to be turned on in the first row. Then, a discharge is generated between the Y electrode in the first row and the A electrode applied with the voltage Va, and accordingly, the (+) wall charges are formed on the Y electrode and the (−) wall charges are formed on the A electrode and X electrode. As a result, a wall voltage (Vwxy) is formed between the X and Y electrodes such that a potential of the Y electrode becomes higher than the same of the X electrode. Subsequently, the address pulse of the voltage Va is applied to the A electrode on cells to be turned on in a second row while the scan voltage VscL is applied to the Y electrode (Y2 shown in FIG. 2) in the second row. Then, the address discharge is generated in the cells crossed by the A electrodes applied with the voltage Va and the Y electrode in the second row, and accordingly, the wall charges are formed in such cells, in the like manner described above. Regarding Y electrodes in other rows, wall charges are formed in cells to be turned on in the same manner as has been described above, i.e., by applying the address pulse of the voltage Va to A electrodes on cells to be turned on while sequentially applying scan pulse of the voltage VscL to the Y electrodes.

In such an address period, conditions of the voltage VscL of the scan pulse for stably generating a discharge are now described.

As described above, in the finishing point of the reset period, a sum of the wall voltage between the A and Y electrodes and the external voltage Vnf between the A and the Y electrodes reaches the discharge firing voltage Vfay between the A and Y electrodes. At this time, when the voltage VscL of the scan pulse is the same as the voltage Vnf, in the address period, discharge may be generated at all the Y electrodes to which the scan pulse is applied. That is, when the 0V is applied to the A electrode and the voltage VscL is applied to the Y electrode, the voltage Vfay is formed between the A and Y electrodes, and accordingly the discharge may be expected to be generated. However, in this case, the discharge is not generated because a discharge delay is greater than the width of the scan pulse and the address pulse. If the voltage Va is applied to the A electrode and the voltage Vnf is applied to the Y electrode, a voltage greater than the voltage Vfay is formed between the A and Y electrodes, and accordingly the discharge delay is reduced to less than the width of the scan pulse. Therefore, the discharge may be generated. At this time, generation of the address discharge may be facilitated by setting the voltage Va to become increased or setting the voltage VscL to become reduced.

In order to apply the voltage Va and 0V to the A electrode, one single switching circuit (not shown) is coupled with one single A electrode. Such a switching circuit includes first and second switches coupled with power sources for respectively supplying the voltage Va and 0v to the A electrode. In addition, the switching circuit is formed on a variable coupling member (not shown) connecting the A electrode to the address buffer board 100. Switching numbers of the switching circuit are determined by numbers of the Y electrodes. For example, when the PDP has 480 Y electrodes in a single driving scheme, the switching circuit can switch a maximum of 480 times in the address period. That is, the switching circuit repeats turn-on/turn-off of the first and the second switch such that the voltage Va and 0V is respectively applied to the odd and even numbered Y electrodes.

In this case, when the voltage Va is high, the first and second switches are heated. This causes the variable coupled members to be damaged. Therefore, in this embodiment, the voltage Va is set to be less than a constant voltage, and the voltage VscL is set to be less than the voltage Vnf as in Equation 1.
VscL<Vnf (Equation 1)

Subsequently, in the sustain period, a sustain discharge is generated between the Y and X electrodes by initially applying a pulse of the voltage Vs to the Y electrode to generate because the wall voltage Vwxy is formed such that the potential of the Y electrode is higher than the same of the X electrode in the cells having undergone the address discharge in the address period. In this case, the voltage Vs is set to be less than the discharge firing voltage Vfxy, and a voltage value (Vs+Vwxy) is set to be higher than the voltage Vfxy. As a result of the sustain discharge, the (−) wall charges are formed on the Y electrode and the (+) wall charges are formed on the X and A electrodes, such that the potential of the X electrode is higher than the same of the Y electrode.

Now, since the voltage Vwyx is formed such that the potential of the Y electrode becomes higher than the same of the X electrode, a pulse of a negative voltage −Vs is applied to the Y electrode to fire a subsequent sustain discharge. Therefore, the (+) wall charges are formed on the Y electrode and the (−) wall charges are formed on the X and A electrodes such that another sustain discharge may be generated by applying the voltage Vs to the Y electrode. Subsequently, the process of alternately applying the sustain discharge pulses of voltages Vs and −Vs voltage to the scan electrode Y is repeated by a number of times corresponding to a weight value of a corresponding subfield.

As described above, when the voltage Vnf is applied in the reset period, the sum of the wall voltage between the A and Y electrodes and the external voltage Vnf between the A and the Y electrodes is determined by the discharge firing voltage Vfay between the A and Y electrodes. In addition, the sustain discharge pulses of voltages Vs and −Vs voltage are alternately applied to the Y electrode in the sustain period. At this time, the sustain discharge is not generated in cells that have not undergone an address discharge even though the voltage −Vs is applied to the Y electrode. However, If the voltage −Vs is less than the voltage Vnf, the sustain discharge may be generated in the cell being turned off by the voltage −Vs. Therefore, in this embodiment, the −Vs voltage is set to satisfy Equation 2.
−Vs>Vnf (Equation 2)

Accordingly, Equation 3 may be extracted from Equation 1 and Equation 2.
VscL<Vnf<−Vs (Equation 3)
VscL<−Vs

As described above, according to an exemplary embodiment of the present invention, reset, address, and sustain operations may be performed by a driving waveform applied only to the Y electrode while the X electrode is biased at the reference voltage. Accordingly, a driving board for driving the X electrode is not required and the X electrode may be simply biased at the reference voltage.

According to an exemplary embodiment of the present invention, the voltages Vs and −Vs are alternately applied to the Y electrode while in the sustain period, and the X electrode and the A electrode are biased at the reference voltage. In this case, when all the cells have the same condition, since the wall charges are not accumulated in the non-selected cell, a discharge may not be generated between the Y electrode and the A electrode of the non-selected cell even though the voltages Vs and −Vs are applied to the Y electrode in the sustain period. However, when the voltages Vs and −Vs are applied to the Y electrode in the sustain period, a misfiring discharge may be generated between the X and Y electrodes of the non-selected cell in the sustain period by the uneven wall charge state between the cells.

Therefore, another exemplary embodiment of the present invention for preventing this misfiring discharge will be described.

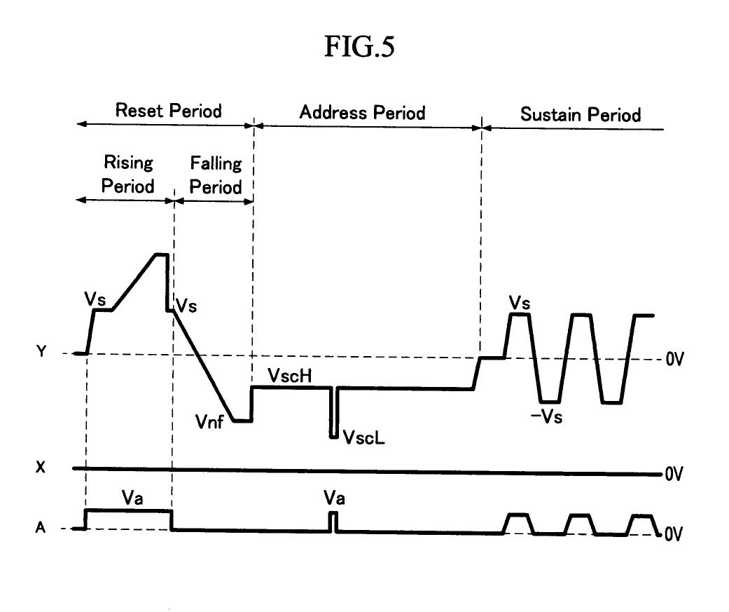

FIG. 5 shows a diagram for representing a driving waveform according to another exemplary embodiment of the present invention. The redundant part will not be described because driving waveforms of the reset period and address period according to the another exemplary embodiment of the present invention are similar to the same according to the initial exemplary embodiment of the present invention.

As shown in FIG. 5, in order to prevent misfiring between the A electrode and the Y electrode, during the sustain period the A electrode is floated or the address voltage Va is applied to the A electrode when the voltage Vs is applied to the Y electrode. Since a voltage difference between the A electrode and the Y electrode is decreased, misfiring may be prevented between the A electrode and Y electrode of non-selected cells during the address period.

As shown in FIG. 5, the A electrode may be biased at a positive voltage during the rising period of the reset period. At this time, it is not necessary to form an additional voltage to be applied to the Y electrode when the reference voltage 0V is used for the falling start voltage.

The wall potential of the Y electrode with respect to the X electrode is greater than the same with respect to the A electrode. Therefore, when the voltage of the Y electrode is increased in the rising period of the reset period, the voltage between the X and Y electrodes may exceed the discharge firing voltage in a predetermined time after the voltage between the A and Y electrodes exceeds the discharge firing voltage Vfay. In addition, The Y electrode operates as an anode and the A electrode and X electrode operate as a cathode because a high voltage is applied to the Y electrode in the rising period of the reset period. The discharge in the cell is determined by an amount of second electrons emitted from the cathode when positive ions collide against the cathode, which is referred to as a “process.”

Generally, in the plasma display panel, the A electrode is covered with a phosphor for color representation, and the X and Y electrodes are covered with a dialectic layer consisting of MgO for increasing sustain-discharge performance. The secondary electron emission coefficient of the dialectic layer consisting of MgO is high, and the secondary electron emission coefficient of the phosphor layer is low. However, in the rising period, the discharge may be delayed between the A and Y electrodes because the A electrode covered with the phosphor operates as the cathode when the voltage between the A and Y electrodes exceeds the discharge firing voltage Vfay. Due to the discharge delay, the voltage between the A and Y electrodes is greater than the discharge firing voltage at the time that the discharge is practically generated between the A and Y electrodes. Accordingly, a strong discharge, not the weak discharge, may be generated between the A and Y electrodes by the high voltage caused by the discharge delay. Another strong discharge may be generated between the X and Y electrodes by the strong discharge between the A and Y electrodes, and therefore positive wall charges are generated in the cells to more than the same generated in a normal rising period, and a great number of priming particles are generated. Accordingly, the strong discharge may be generated by the wall charges and the priming particles in the falling period, and the wall charges may not be properly eliminated between the X and Y electrodes so that the misfiring discharge may be generated between the X and Y electrodes by the high wall voltage in the sustain period.

According to an exemplary embodiment of the present invention, when the voltage of the Y electrode is increased while the A electrode is biased at the voltage Va, the voltage between the A and Y electrodes is less than the same in the first exemplary embodiment, and therefore the voltage between the X and Y electrodes exceeds the discharge firing voltage before the voltage between the A and Y electrodes exceeds the discharge firing voltage. The voltage between the A and Y electrodes exceeds the discharge firing voltage while the weak discharge is generated between the X and Y electrodes, and the priming particles are formed by the weak discharge. The discharge delay is reduced between the A and Y electrodes by the priming particles. Accordingly, the weak discharge is generated instead of the strong discharge, and the wall charges are properly formed. In addition, the misfiring discharge may be prevented because the strong discharge is not generated in the falling period of the reset period

As described above, according to an embodiment of the present invention, reset, address, and sustain operations may be performed by a driving waveform applied only to the Y electrode while the X electrode is biased at the reference voltage. Accordingly, a driving board for driving the X electrode is not required and the X electrode may be simply biased at the reference voltage.

In an exemplary embodiment of the present invention, the driving waveform is applied to the Y electrode while the X electrode is biased at a predetermined voltage Y electrode. However, the driving waveform may be applied to the X electrode while the Y electrode is biased at a predetermined voltage.

In addition, it has been described that the X electrode is biased at a predetermined voltage during the entire operating period. However, the present invention is not limited thereto.

According to the exemplary embodiments of the present invention, a board for driving the sustain electrode is not required because the driving waveform is applied to the scan electrode while the sustain electrode is biased at a predetermined voltage. That is, a single integrated board for driving the electrodes is practically realized, and the cost is reduced.

In addition, according to the exemplary embodiments of the present invention, the impedance on the path for applying the sustain discharge pulse may be controlled to be within a certain level because the pulse for the sustain discharge is supplied from the scan driving board.

In addition, the misfiring discharge may be prevented during the sustain period when the low voltage −Vs applied to the scan electrode during the sustain period is set to be greater than the scan voltage −VscL applied to the scan electrode during the address period.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method of a plasma display device having a plurality of first electrodes, a plurality of second electrodes, and a plurality of third electrodes formed crossing the first electrodes and the second electrodes, and having a discharge cell formed by the first electrodes, the second electrodes, and the third electrodes while one frame is divided into a plurality of subfields, at least one subfield including a reset period, an address period and a sustain period, the method comprising:
while biasing the second electrode at a first voltage during the at least one subfield,
in the reset period, initializing the discharge cell by gradually decreasing a voltage of the first electrodes from a second voltage to a third voltage;
in the address period, applying a fourth voltage to the first electrodes of a discharge cell to be turned on and a fifth voltage greater than the first voltage to the third electrodes of the discharge cell to be turned on; and
in the sustain period, alternately applying a sixth voltage greater than the first voltage and a seventh voltage less than the first voltage and greater than the fourth voltage to the first electrodes.

2. The driving method of claim 1, wherein the fourth voltage is less than the first voltage.

3. The driving method of claim 1, wherein the fifth voltage is applied to the third electrode while the sixth voltage is applied to the first electrode.

4. The driving method of claim 1, wherein the third electrodes are floated while the sixth voltage is applied to the first electrodes.

5. The driving method of claim 1, further comprising gradually increasing the voltage of the first electrodes from an eighth voltage to a ninth voltage before gradually decreasing the voltage of the first electrodes,
wherein the fifth voltage is applied to the third electrodes in at least a partial period of the reset period when the voltage of the first electrodes is increased from the eighth voltage to the ninth voltage.

6. The driving method of claim 1, further comprising gradually increasing the voltage of the first electrodes from an eighth voltage to a ninth voltage before gradually decreasing the voltage of the first electrodes,
wherein the third electrodes are floated in at least a partial period when the voltage of the first electrodes is increased from the eighth voltage to the ninth voltage.

7. The driving method of claim 1, further comprising sequentially
applying the fourth voltage to the plurality of first electrodes,
applying the fifth voltage to the third electrodes of turn-on discharge cells among a plurality of discharge cell selected by the first electrodes applied with the fourth voltage, and
applying the first voltage to other third electrodes.

8. The driving method of claim 1, wherein the first voltage is a ground voltage.

9. A plasma display device comprising:
a plasma display panel having a plurality of first electrodes, a plurality of second electrodes, and a plurality of third electrodes crossing the first electrodes and the second electrodes; and
a chassis base facing the plasma display panel and including a driving board for applying a driving waveform to the second electrodes and the third electrodes so as to display an image on the plasma display panel and for biasing the first electrode to a first voltage while the image is displayed,
wherein, for at least one subfield,
in an address period, the driving board biases the plurality of second electrodes at a first voltage, applies a second voltage to the plurality of first electrodes, selectively applies a third voltage greater than the first voltage to the plurality of third electrodes, and
in a sustain period, the driving board alternately applies high levels and low levels of a sustain discharge pulse to the plurality of first electrodes, an absolute value of a low level of the sustain pulse being less than an absolute value of the second voltage.

10. The plasma display device of claim 9, wherein the driving board controls a voltage of the third electrodes to be higher than the first voltage when a high level of the sustain pulse is applied to the first electrodes.

11. The plasma display device of claim 10, wherein discharge cells formed at intersection regions of the first electrodes applied with the second voltage and the third electrodes applied with the third voltage are selected as a turn-on discharge cell.

12. The plasma display device of claim 9, wherein in the reset period, the driving board gradually decreases the voltage of the plurality of first electrodes from a fourth voltage to a fifth voltage, and the fifth voltage is less than the low level of the sustain pulse applied to the plurality of first electrodes.

13. The plasma display device of claim 12, wherein in the reset period, the driving board gradually increases the voltage of the first electrodes from a sixth voltage to a seventh voltage before the voltage of the first electrodes is gradually decreased from the fourth voltage to the fifth voltage, and controls the voltage of the third electrodes to be greater than the first voltage in at least a partial period when the voltage of the first electrodes is gradually increased.
